(19) United States
(12) Patent Application Publication
(10) Pub. No.: US 2007/0134468 A1
(43) Pub. Date: Jun. 14, 2007

(54) Enhanced friction reducing surface and method of making the same

(76) Inventor: Jane E. Buehler, Spokane, WA (US)

Correspondence Address: JACOBSON HOLMAN PLLC, 400 SEVENTH STREET N.W., SUITE 600, WASHINGTON, DC, 20004, US

(21) Appl. No.: 11/179,633

(22) Filed: Jul. 13, 2005

Related U.S. Application Data
(60) Provisional application No. 60/587,512, filed on Jul. 14, 2004.

(51) Int. Cl. G11B 5/64

(52) U.S. Cl. 428/141

(57) ABSTRACT

A process for producing an enhanced friction reducing surface by bonding a dry lubricant to a substrate by way of high velocity mechanical impact and low temperature diffusion bonding, and the friction-reduced surface produced thereby. Kinetic energy produced from the mechanical impact drives the lubricant against the surface of the substrate, forming a metallurgical bond between the lubricant and the substrate surface. Performance of a subsequent low temperature solid state diffusion bonding step at less than half the melting point of the substrate causes, in combination with the stored bond energy, causes the lubricant to penetrate into the sub-surface of the substrate. The resulting substrate, modified at the sub-surface level but without any loss of metallurgical characteristics, demonstrates significantly improved wear and friction-reducing characteristics.

This application is entitled to and hereby claims the priority of co-pending U.S. Provisional application Ser. No. 60/587,512 filed Jul. 14, 2004, which is hereby incorporated by reference in its entirety as if fully set forth herein.

### BACKGROUND OF THE INVENTION

1. Field of the Invention

The present invention relates to the application of dry lubricants to metal substrates and, more particularly, to an enhanced friction-reducing surface and method by which a dry lubricant layer is applied both onto and into the metal substrate surface for enhanced wear performance over time.

2. Description of the Related Art

Films of friction-reducing dry lubricants such as molybdenum disulfide (MoS₂), tungsten disulfide (WS₂), graphite, etc. have been applied to various metal substrates, generally by spraying or dipping methods followed by drying or baking. Other methods such as chemical and vapor deposition have also been used.

The transfer of the dry lubricant film to the metal substrate according to these traditional methods is primarily a mechanical process by which a mixture of dry lubricant chemicals and peening particles is impacted against the substrate at a high enough velocity to adhere a thin layer of the dry lubricant chemicals to the top of the substrate surface. This thin layer may be adequate for certain limited applications, but when the treated surface is subjected to high wear, the dry lubricant is quickly removed. As a result, metal parts such as pistons, rings, bearings, journals, valve stems, shafts, and the like, which could greatly benefit from the low friction characteristics and protection provided by dry lubricants, are often excluded from treatment or obtain limited benefit therefrom due to the rapid deterioration in the lubricant coating in such high-wear environments.

So far as is known, no feasible way has emerged for treating metal surfaces with friction-reducing dry lubricant chemicals in such a way that the dry lubricant forms a long-wearing, high-endurance surface layer and in which the process required for application of the layer is manufacturer friendly.

### SUMMARY OF THE INVENTION

It is therefore a major object of the present invention to provide a reduced-friction surface meeting the above needs. Accordingly, the present invention is directed to a process by which dry lubricant is applied onto the surface of a metal substrate so as to penetrate therein, and the modified substrate resulting from such process.

According to the inventive method, the substrate to be treated is first pre-cleaned and then impinged with an abrasive media to create an interlocking, oxide-free surface suitable for application of a dry lubricant. After removing residual abrasive media from the substrate surface, the dry lubricant mixed with shot particles is applied thereto via a conventional shot peening technique which produces enough kinetic energy upon impact of the shot particles against the metal substrate that not only is the dry lubricant driven into the surface, but a strong metallurgical bond is formed. Excess unbonded lubricant is removed and the lubricant metallurgically bonded to the metal substrate is then low temperature diffusion bonded at a temperature of less than 50% of the melting point of the metal substrate. The stored energy from the metallurgical bond, in combination with the low temperature heating, combine to cause the dry lubricant to migrate more deeply into the sub-surface of the substrate. If desired, another application of dry lubricant may be thereafter applied to the substrate to finish the surface, with a final cleaning operation at the conclusion thereof.

The present invention is further directed to a modified substrate having an outer surface layer mechanically bonded with a dry lubricant and a sub-surface layer beneath the outer layer into which said dry lubricant has penetrated. Such a modified substrate made by the disclosed method, namely through impingement processing followed by low temperature diffusion bonding, is also within the intended scope of the present invention.

Accordingly, it is an object of the present invention to provide a process that produces, through the combination of impingement with solid state low temperature diffusion bonding, a deeper penetration of the friction-reducing dry lubricant into the surface and sub-surface of the metal substrate than is possible with conventional shot peening techniques alone.

It is another object of the present invention to provide a process for treating metal surfaces which reduces friction thru dry lubricant penetration while maintaining the dimensional integrity of the part being treated.

It is a further object of the present invention to provide a method that creates a clean and roughened surface on the metal substrate to allow for a dry lubricant to be applied by high velocity impact through conventional shot peening techniques to form a strong continuous bond between the dry lubricant and the metal surface which, when combined with low temperature diffusion bonding, enables the lubricant to penetrate into the sub-surface of the substrate.

It is yet another object of the present invention to provide a process for surface friction reduction in which the kinetic energy created from high velocity impact of peening particles on a metal surface creates a superior bond between the dry lubricant and the metal surface, rendering the metal surface amenable to low temperature diffusion bonding with the dry lubricant so as to produce further penetration of the lubricant without changing the grain structure of the metal substrate.

It is a further object of the present invention to provide a reduced-friction surface that, through modification of the sub-surface so as to increase lubricant integration with the substrate itself, is suitable for use with a wide range of products that require increased surface wear endurance properties.

It is a still further object of the present invention to provide a modified metal substrate, and treatment for producing the same, that has an outer layer dimensional modification of less than 10 microns while the underlying substrate sub-surface structure is modified to a depth of about 5-50 microns.

It is yet another object of the present invention to provide a reduced-friction substrate, having an outer surface impacted by shot peening with dry lubricant and a sub-surface penetrated by the dry lubricant, that is easy to manufacture and highly durable in use.

These together with other objects and advantages which will become subsequently apparent reside in the details of construction and operation as more fully hereinafter described and claimed, reference being had to the accompanying drawings forming a part hereof, wherein like reference characters refer to like parts throughout.

### BRIEF DESCRIPTION OF THE DRAWING

FIG. 1 is a flowchart of the method steps for producing a reduced-friction surface, in accordance with the present invention.

FIG. 2 is a magnified view of lubricant penetration into a substrate surface following diffusion treatment versus the penetration obtained on a second substrate surface which had not been treated with diffusion bonding.

FIG. 3 depicts a dimensional comparison of high precision metal samples with measurements taken before and after diffusion treatment of the samples.

FIG. 4 is a graph illustrating frictional test results obtained during testing of disc surfaces treated with diffusion bonding versus untreated surfaces.

FIG. 5 is a graph illustrating operating temperatures obtained on disc surfaces treated with diffusion bonding versus untreated surfaces during the testing of FIG. 4.

FIG. 6 depicts the differences in wear incurred on a ball bearing subjected to load as it slides on a disc surface treated with diffusion bonding versus an untreated surface during the testing of FIG. 4.

FIG. 7 is a comparative graph of duration to failure between a disc treated with the diffusion process versus an untreated disc, under a first set of test conditions.

FIG. 8 is a comparative graph of duration to failure between a disc treated with the diffusion process versus an untreated disc, under a second set of test conditions.

FIG. 9 is a comparative graph of duration to failure between a disc treated with the diffusion process versus an untreated disc, under a third set of test conditions.

FIG. 10 is a comparative graph of duration to failure between a disc treated with the diffusion process versus an untreated disc, under a fourth set of test conditions.

FIG. 11 is a graph summarizing the results of FIGS. 7-10.

### DETAILED DESCRIPTION OF THE PREFERRED EMBODIMENTS

In describing a preferred embodiment of the invention, specific terminology will be resorted to for the sake of clarity. However, the invention is not intended to be limited to the specific terms so selected, and it is to be understood that each specific term includes all technical equivalents which operate in a similar manner to accomplish a similar purpose. Furthermore, the preferred embodiments herein described are not intended to be exhaustive or to limit the invention to the precise forms disclosed. Rather, they are chosen and described to best explain the invention so that others skilled in the art might utilize its teachings.

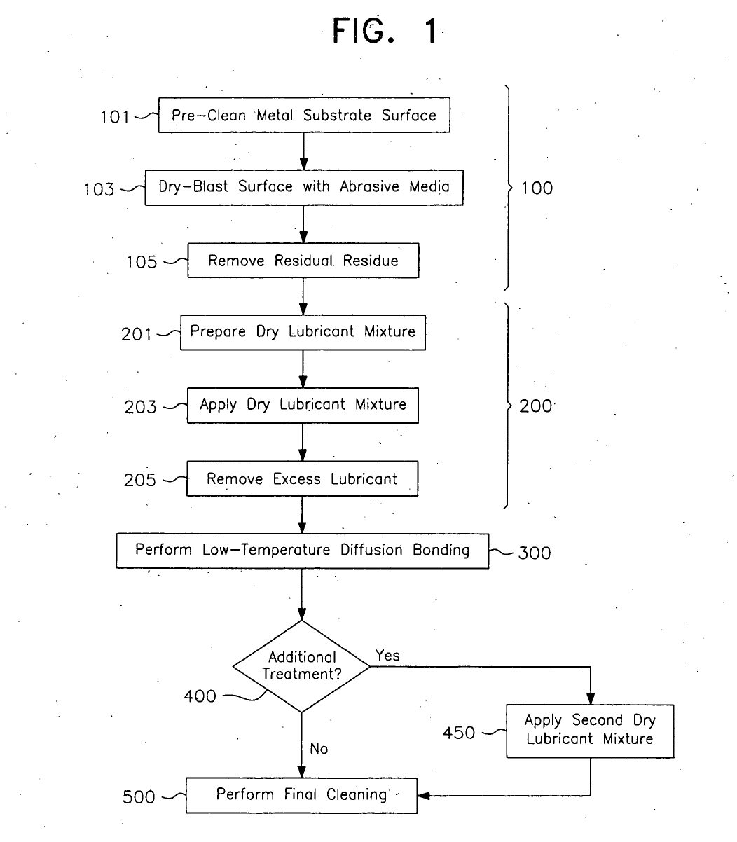

According to the method of the present invention, a metal surface is treated so as to form a dry lubricant layer thereon that demonstrates greater depth and adherence than that produced using only conventional shot peening techniques. As will be discussed in greater detail hereinafter and as summarized in FIG. 1, the method broadly includes the steps of cleaning the surface, step 100, applying the dry lubricant thereto by impingement, step 200, and causing the lubricant to penetrate more deeply into the surface and sub-surface through subsequent low temperature diffusion bonding, step 300.

As used herein, the term “surface” is intended to refer to the outermost layer of a substrate as one would understand that term in conjunction with the part of the substrate or other object that is subject to tactile manipulation or touch, as in the “surface” of a table. Conventional shot peening or impingement processes affect only the substrate surface, creating a roughened texture to which the lubricant is better able to adhere, while not altering the sub-surface of the substrate. The term “sub-surface” is used herein to refer to portions of the substrate that are beneath the surface and therefore not normally accessible to touch, being covered by the surface layer.

The method of the present invention is suitable for a range of substrates and dry lubricants. Representative metal substrates include aluminum, titanium, copper, and the alloys thereof, as well as steel and various combinations of the foregoing metals. Substrates of ceramic and polymer may also be effectively treated.

In view of the variation in substrates to which the present invention may be applied, some variation in the specific performance of the method is generally necessary or advisable to best accommodate the specific substrate being used. Accordingly, a step preliminary to the conduct of the method is to obtain the part to be treated and to understand the surface specifications for the part so as to be able to stay within those specifications throughout the treatment process. For example, in selecting a cleaning abrasive for the cleaning step, depending upon the abrasive and the type of metal in the substrate, use of the abrasive may have an adverse impact on, i.e., increase, the surface roughness. This can occur with abrasives having hard particles or particles that are jagged in shape. Hence, use of such an abrasive is not advised when the part specification requires that the surface roughness of the part remain the same.

Once the part has been identified and its associated specifications taken into consideration, treatment of the part according to the present invention may commence.

As shown in the figure, the first step is to clean the part that is to be treated, step 100. Cleaning is preferably undertaken in three phases, namely pre-cleaning, step 101; abrasive cleaning, step 103; and the removing of excess abrasive media, step 105.

Pre-cleaning of the part, step 101, is performed to remove any obvious surface contaminants such as oil residue or dirt. Pre-cleaning allows for a more efficient abrasive cleaning step while also avoiding contamination of the blast cabinet and abrasive media to be used in step 103 such that they can be readily recycled for additional use.

Depending on the specific part, the pre-cleaning step, step 101, can be performed by blowing the part off with compressed gas (typically, air, nitrogen or argon), polishing the part in a tumbler with an abrasive media and/or by taking a clean cloth and wiping the surface. While the cloth can be dry, more preferably the cloth is saturated with a solvent that removes the surface contaminants. Care must be taken to ensure that the solvent chosen does not have an adverse effect on the surface (for example, the use of chlorine on a stainless steel surface will cause intergranular cracking). The cleaning material may generally be any of water, acetone, mineral spirits, solvents, surfactants, or combinations of the foregoing. For a more intense pre-clean, a sonic cleaner may be used to clean the part.

After the part is pre-cleaned, it is ready for abrasive cleaning, step 103. Abrasive cleaning is generally performed by dry blasting the metal substrate with an abrasive media in an enclosure such as a blasting cabinet. The goal of dry blasting is to clean the surface of residual oxides and create an interlocking surface such that the dry lubricant chemical, when applied, latches onto and is held to the surface of the substrate. In addition, the abrasive cleaning step increases the available surface area, resulting in substantial improvement for bonding of the dry lubricant onto the surface of the substrate.

There is a wide range of abrasive media that can be chosen depending on how contaminated the surface is and what care is needed when pre-cleaning in order to stay within the part surface specifications. If there are no surface specifications, then a coarser and more abrasive cleaning media can be used, such as slag or carbide. If, on the other hand, the specification provides that the surface roughness is to be minimized, then an appropriate abrasive media would be fine glass beads, fine aluminum oxide, or other comparable abrasive media as would be known in the industry.

During the abrasive treatment, the abrasive media is entrained in a carrier gas, generally ambient air, and is directed against the substrate surface through one or more nozzles within the cabinet enclosure. The cabinet enclosure may contain an ambient air atmosphere or may have a controlled environment, i.e., an inert gas such as argon, in order to control oxidation. The need for a controlled environment will depend upon the mix of dry lubricant being used and the composition of the metal substrate.

The distance between the nozzle and the substrate surface during the abrasive treatment can be from about 0.5-6 inches, but preferably is about four inches, with a nozzle pressure ranging from 40-180 psi, and more preferably from about 80 psi-120 psi. The nozzle may be angled to be as oblique as 10 degrees relative to the substrate surface, but it is preferable to have the nozzle oriented to be substantially perpendicular to the substrate surface.

After the part has been uniformly cleaned, residual residue from the abrasive cleaning media is removed, step 105. The residual residue removal step is preferably performed by directing a compressed gas, generally air, nitrogen or argon, against the substrate surface with sufficient pressure to remove any residual abrasive cleaning media remaining adhered thereto.

When cleaning is complete, the surface is ready for application of the dry lubricant by impingement, step 200. This stage of the method includes two phases, namely preparation of a dry lubricant mixture, step 201, and application thereof to the substrate, step 202.

During dry lubricant mixture preparation, step 201, a dry lubricant mixture is made from a combination of various dry lubricants (generally metal and polymer) and peening particles. The dry lubricant mixture is mixed in an efficient way, such as with a Vee mixer, for the purpose of minimizing electrostatic and agglomeration, while maximizing the coverage of the lubricant powders onto the shot.

As a step preliminary to preparation of the mixture, a dry lubricant powder must be chosen. Typically this is MOS₂ and the polymer PTFE. However, a range of dry lubricants may be suitably used, including titanium, tungsten disulfide, ruthenium, carbon, tantalum, and vanadium.

The carrier media or peening particles are typically clean stainless steel shot which are typically spherical in shape. This shape allows for maximum coverage of the dry lubricant over the surface of the carrier media. The shape is also important in that, upon impact into the surface, the round shot limits the likelihood that the surface will be notched which could, in turn, create stress risers to the surface which can initiate cracks and other failures. The round shape also allows for surface compression which increases surface strength and minimizes corrosion. In addition, round shape decreases grain boundary exposure which, in turn, minimizes corrosion as the shot impacts the surface and delivers the lubricant.

When choosing sizes of powder and shot, preferably the grains of dry lubricant are no more than half the size of the shot and, more preferably, are “nano-powder size” which is usually less than 5 microns in diameter. While the size of the shot is typically a function of the hardness of the substrate, it is generally desirable to use shot size that is as small as possible from what is available, with a typical size being about 0.008 inches; however, sizes of up to 0.330 inches in diameter may be used.

When mixing the lubricant powder with the shot, enough powder has to be applied to adequately coat the shot. Care also needs to be taken when choosing the mixing technique used to coat the powder onto the shot. The purpose of the mixing is to thoroughly coat the carrier media with the dry powder(s). If this step is not done properly, several problems occur with the mixture which have an adverse effect on the impingement process step.

Specifically, problems in the mixing process lead to a mixture which exhibits degrees of segregation between the powders as well as between the powders and the carrier media, agglomeration of the powders, electrostatic charges which prevent a thorough coating of the powders to the carrier media, de-mixing of the mixture, and oxidation of the lubricant powders as well as the carrier media. Segregation, electrostatic charges and de-mixing result in poor coating of the media with the powders. This, in turn, results in less powder being transported and impinged upon the substrate by the carrier particles, resulting in non-uniform application of the lubricant powder to the substrate.

Agglomeration issues in the final mixture also lead to non-uniform treatment of the powder onto the substrate. Agglomerated powders leave heavy residue on the parts which flakes off and leads to an increase in friction rather than an improvement therein when the parts are ultimately placed into service. Finally, heavy oxidation of the powders in the mix will cause non-effective impingement of the powders to the substrate.

A blender that is the most effective to obtain a mixture best suited for the impingement process must achieve maximum blending in a minimum time, provide repeatability in blending result, allow for a gentle mixing, and provide a dust-tight environment. There are two primary types of blenders which meet these criteria. The first is the tumble-type blender which typically includes drum-type, double cone, twin shell or vee-blenders, and cross flow blenders. The second type is the low shear agitation-type blender using ribbons, low speed paddles, screw-type augers, and other means of moving components on a stationary vessel.

The duration and intensity of the mixing process when combining the powders and the carrier media will affect the properties of the final mixture that is obtained. Mixing times may range from five minutes to four hours but, typically, a mixing time of between 10-80 minutes is appropriate.

To keep the oxidation of the mix as well as the powders and carrier media to a minimum, the blending vessel needs to be airtight and, if possible, back-filled with an inert gas; typically argon or nitrogen is used.

While the step of preparing the dry lubricant mixture is shown in the figure as following the cleaning, step 100, preparation of the dry lubricant mixture could, of course, be completed prior to the cleaning step or concurrently therewith as would be understood by persons of ordinary skill in the art. Accordingly, the invention is not intended to be limited to the specific sequence shown in the figure, except to the extent that the cleaning, step 100, precedes the peening process, step 200, which, in turn, precedes the low temperature diffusion bonding, step 300.

After blending the dry lubricant mixture, step 201, the mixture is transferred into a process cabinet or similar enclosure for the application of the mixture to the substrate, step 203. Care must be taken to avoid re-contamination of the cleaned part, and the use of gloves at all times is recommended.

It is also advisable to use a separate process cabinet or enclosure from that used during the cleaning, step 100, to prevent contamination. More specifically, according to the present invention, it is preferred that the processing carrier media used to apply the lubricant, step 203, be different from the abrasive media used during the cleaning, step 100. For example, the abrasive cleaning media may be aluminum oxide or glass beads, while the processing carrier media is preferably stainless steel shot. To avoid cross-contamination between the cleaning and processing media, therefore, it is preferable that two separate enclosures be used for these two steps.

The process settings for the dry lubricant application or peening step, step 203, are very similar to those used during the abrasive cleaning, step 103. The peening particles are entrained in a carrier gas, generally ambient air, and are directed against the substrate surface through one or more nozzles within the cabinet enclosure. The cabinet enclosure may contain an ambient air environment or may have a controlled environment, i.e., an inert gas such as argon, in order to control the rate of oxidation. The need for a controlled environment will depend upon the mix of dry lubricant being used and the composition of the metal substrate.

The nozzle distance for peening is generally about four inches from the surface of the substrate, although it may range from about 0.5 inches to 6 inches. The nozzle pressure may be from 40-180 psi, but is preferably in the range of 80-120 psi. While the nozzle may be angled to be as oblique as 10 degrees relative to the substrate surface, it is preferable to have the nozzle oriented to be substantially perpendicular to the substrate surface.

Treatment time for application of the dry lubricant mixture to the metal substrate can range from one to ten minutes, with a treatment duration of approximately 4 minutes generally being preferred.

Interlocking between the dry lubricant powder and the surface of the metal substrate during the impinging step creates a mechanical bond, with pressure from the impingement process pushing the dry lubricant particles into the surface of the substrate. Kinetic energy that results from the collision of the shot hitting the substrate surface essentially provides a low temperature pressure bond, also called a metallurgical bond, of the dry lubricant onto the surface of the metal substrate. Because of the fit and the stored bond energy, this impingement processing, combined with the cleaning step already performed, makes the substrate more conducive to the subsequent step of low temperature diffusion bonding, discussed hereinafter, and eliminates the need for the high temperature processing conventionally associated with diffusion bonding.

As with the cleaning step, the specific parameters of the peening processing treatment are subject to choice and will vary depending on the specific substrate material as well as the specifications and use associated therewith. For example, a longer duration of lubricant mixture application will provide more material to the surface which is good if thickness of the applied layer is desired but which may not be advantageous if the intended use of the items being treated has very tight dimensional specifications. A longer duration may also, in some cases, result in an increase in the energy stored for subsequent migration during low temperature diffusion bonding. Generally, the nozzle distance, nozzle pressure and the size of the shot are all factors that contribute to the amount of energy that is stored for the subsequent step of low temperature diffusion bonding.

After the part has been uniformly processed, it is advisable to inspect the part to ensure that all unbonded dry lubricant powder has been removed. Failure to remove such residue can result in significant performance degradation as the effect of the unbonded lubricant is opposite that intended, namely that friction in the resulting part is increased rather than reduced. Hence, to ensure removal of any residual dry lubricant and carrier media, the surface is preferably blown off by compressed air or other methods, step 205.

Upon completion of the peening processing, step 200, the part is subjected to solid state low temperature diffusion bonding, step 300, carried out in a non-reactive atmosphere. As used herein, low temperature diffusion bonding refers to a heat treatment in an oven or other heating unit at a temperature that is greater than 2% and less than 50% of the melting temperature of the metal substrate. More preferred, the low temperature diffusion bonding occurs in a heating unit at a temperature that is between 20% and 40% of the melting temperature of the substrate, and most typically at a temperature that is about 35% of the melting temperature of the substrate. By keeping the temperature below 50% of the melting point of the metal substrate, the metallurgical characteristics of the substrate, such as grain size, are maintained. Similarly, when using non-metal substrates such as ceramic or polymer, the underlying structure of these materials is preserved through the conduct of low temperature diffusion bonding at a temperature that is at least 2% and less than 50% of the melting point of the respective substrate material.

The low temperature diffusion bonding process not only ensures strong adhesion of the pressurized consolidated dry lubricant on the substrate surface, but also drives the dry lubricant into the sub-surface region of the substrate, thereby making the lubricant part of the base metal. This penetration is achieved at such low temperatures due to the energy stored as a result of the impingement step. The stored energy facilitates migration of the lubricant grains on a molecular level, enabling the diffusion bonding step to be effectively performed at significantly lower temperatures than are possible with conventional diffusion bonding processes. Further, the combination of the stored metallurgical bond energy and the reduced heat of the low temperature diffusion bonding process, results in sub-surface modification of the substrate without the loss of metallurgical characteristics, also unlike prior art diffusion bonding processes.

To achieve this modification of the sub-surface region, the low temperature diffusion bonding process is performed for a period of time until the dry lubricant, previously pressure-bonded by impingement, penetrates the sub-surface of the substrate; preferably this penetration is on the order of at least 2-5 microns. Typically, the diffusion heat treatment has a duration of between about one and four hours, although the treatment may be as brief as one minute or as sustained as 100 hours. As one example, the low temperature diffusion bonding step can be effectively conducted at a temperature of about 400 degrees C. for a period of about 0.5 to 4.0 hours.

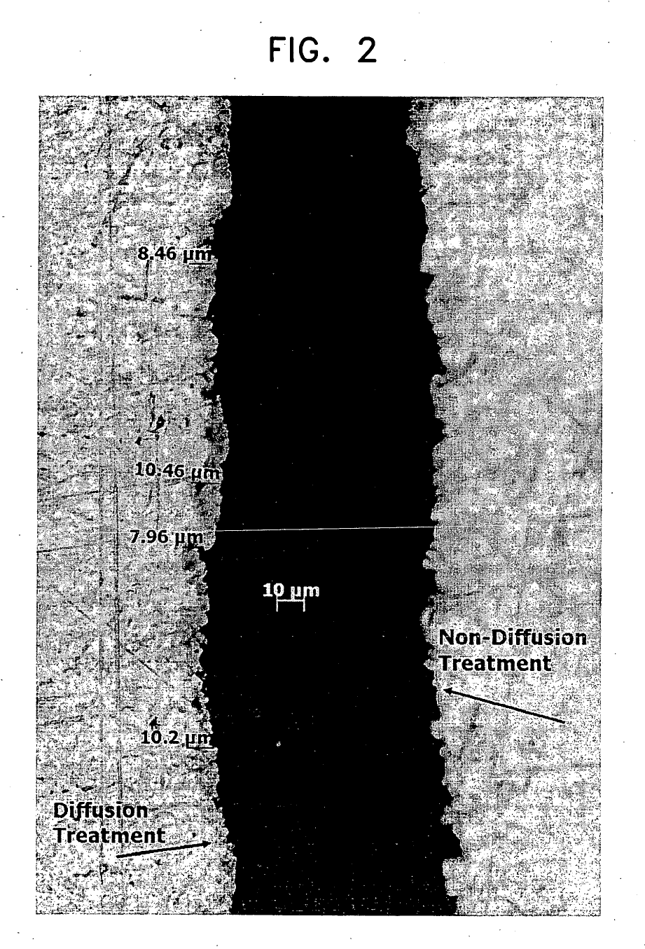

In testing conducted using a 6061 aluminum sample divided into two halves, demonstratable penetration on the order of 8 to 11 microns resulted from treatment of the first sample half with low temperature diffusion bonding, as shown on the left side of FIG. 2. The depth of the sub-surface of the substrate which is affected or modified by the diffusion bonding process may be much greater, e.g., with a modified sub-surface layer on the order of up to 50 microns. The other half of the aluminum sample, shown on the right side of FIG. 2, was not processed by low temperature diffusion bonding and demonstrated no visible penetration of the dry lubricant when examined at 200× magnification. Further details of this testing are set forth in Example I.

Significantly, the solid state low temperature diffusion bonding step according to the present invention is unlike the conventional curing or heat treatment steps known in the prior art. Curing, which may be conducted at a range of temperatures, is intended to remove excess or unwanted moisture remaining in the processed material so as to avoid problems that might otherwise occur as a result of such retained or residual moisture, as when lumber is dried or cured to prevent subsequent warping or when ceramics are cured before kiln treatment. Conventional heat treatments, in which temperatures greater than 50% of the melting point are required, are also unlike the low temperature diffusion bonding of the present invention. In such prior art heat treatments, diffusion bonding is conducted not only at high temperatures but also under pressure from presses such as forges or vacuum hot presses. This presents a significant disadvantage in that surface treatments that require high temperature conditions such as these result in undesirable grain growth of the substrate material. With the present invention, by contrast, the impact pressure resulting from the peening process, step 203, bonds the dry lubricant powders to the substrate with stored energy, allowing for lubricant migration into the sub-surface to occur at reduced temperatures and with no requirement for physically contacting surfaces or the application of pressure to the outer surface of the substrate.

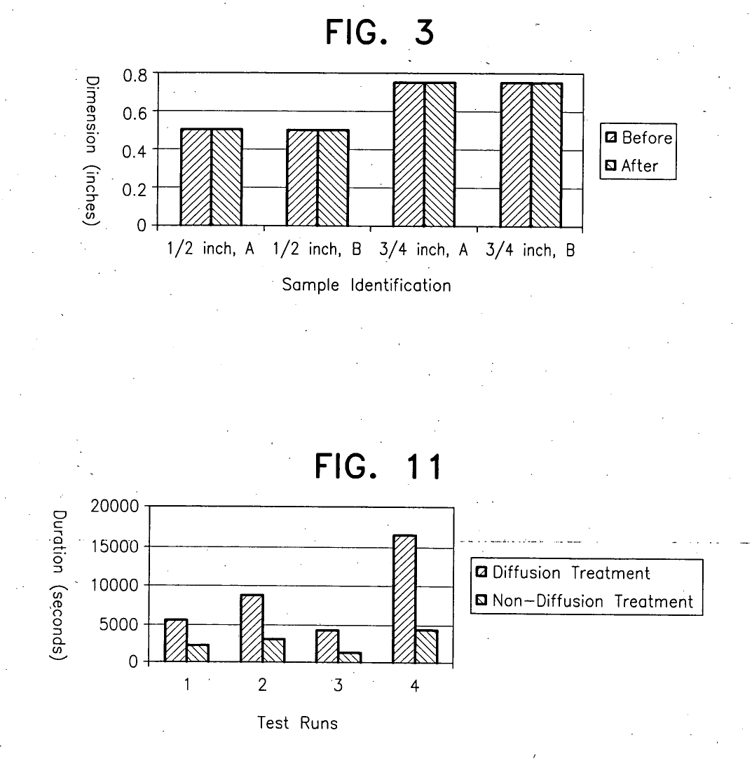

When practiced as described herein, the method according to the present invention produces a reduced-friction outer layer which increases the overall dimension of the substrate surface by not more than about 10 microns, i.e., the increase in the dimensions of the substrate and thus of the part size is minimal so as to reduce or eliminate any problems associated with meeting dimensional specifications associated with the part. The minimal dimensional impact of the low temperature diffusion bonding process has been shown through testing in which the inventive process was applied to high precision metal. Further details of this high precision dimensional testing are set forth in Example II and summarized in FIG. 3. In sum, even with the narrow tolerances to which high precision metal is subject, the variation which resulted between dimensions taken before and after the low temperature diffusion bonding treatment was less than the variation occurring along the length of each bar and, in all cases, was within the reference specification for allowable variation as enumerated in the Ryersen Stock List (Joseph T. Ryerson and Son, Inc., 1995).

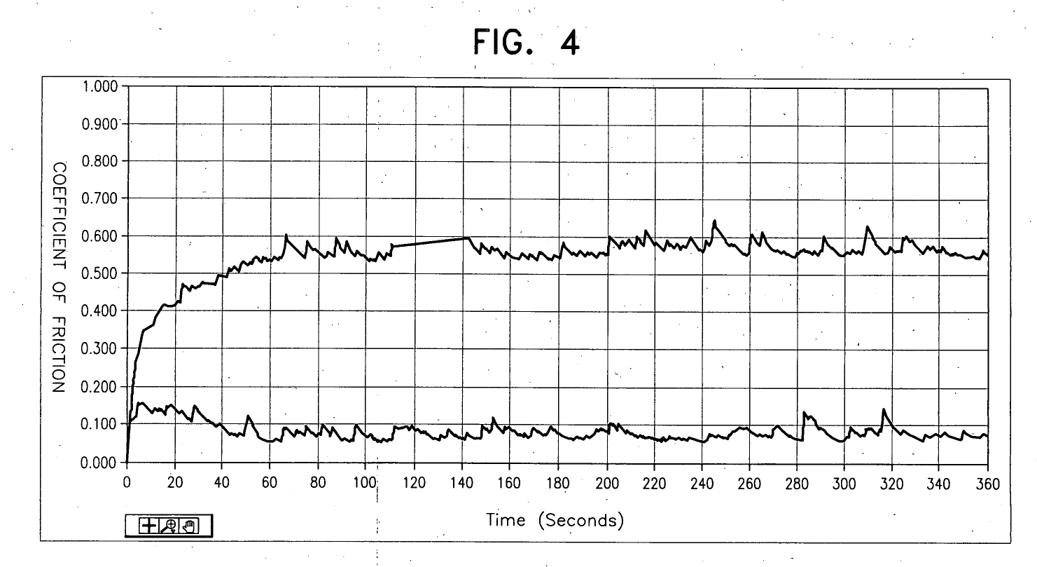

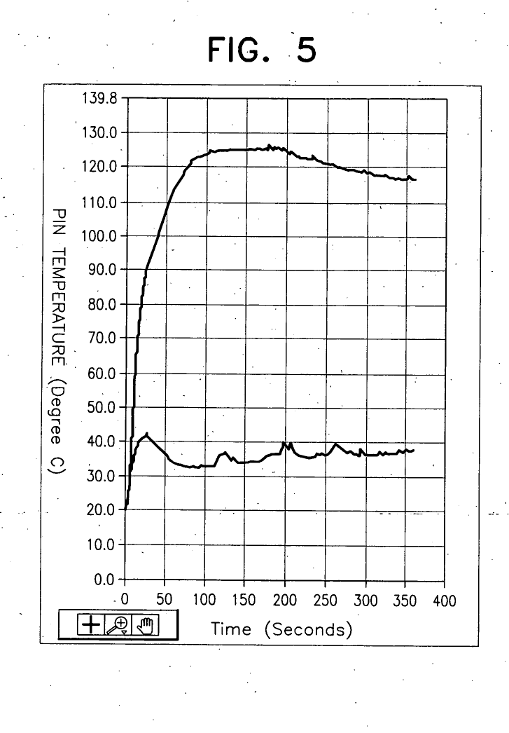

The enhanced penetration obtained with the low temperature diffusion bonding process results in an integrally changed surface in which the modification extends deeply into the sub-surface of the substrate itself to create an outer “mantle”. This mantle, or the combination of the surface and the modified sub-surface layers, results in an outer portion of the substrate that has, during testing with ball bearings sliding thereon, demonstrated a reduction in friction on the order of 85% as compared with the same substrate sample type having an untreated outer surface. These results are presented graphically in FIG. 4. Furthermore, the reduced friction is accompanied by an operating temperature one third that of the temperature recorded with the ball bearing running on the untreated surface, as graphically depicted in FIG. 5.

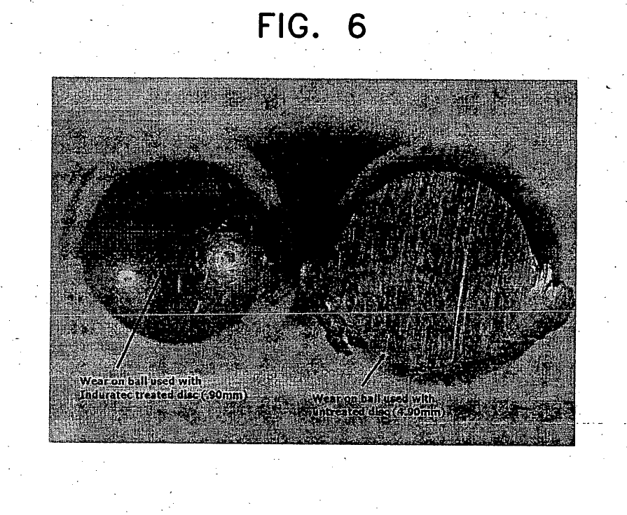

These two factors of reduced friction and lowered temperature contribute to an overall reduction in wear on the ball bearing running on the treated surface of approximately 82% as compared with the wear on the ball bearing running on the untreated surface. As shown in FIG. 6, the ball running on the surface treated with low temperature diffusion bonding processing so as to alter the sub-surface exhibited a wear of about 0.90 mm, while the ball running on the untreated surface suffered wear on the order of 4.90 mm. The details of the testing which produced these results are set forth in Example III.

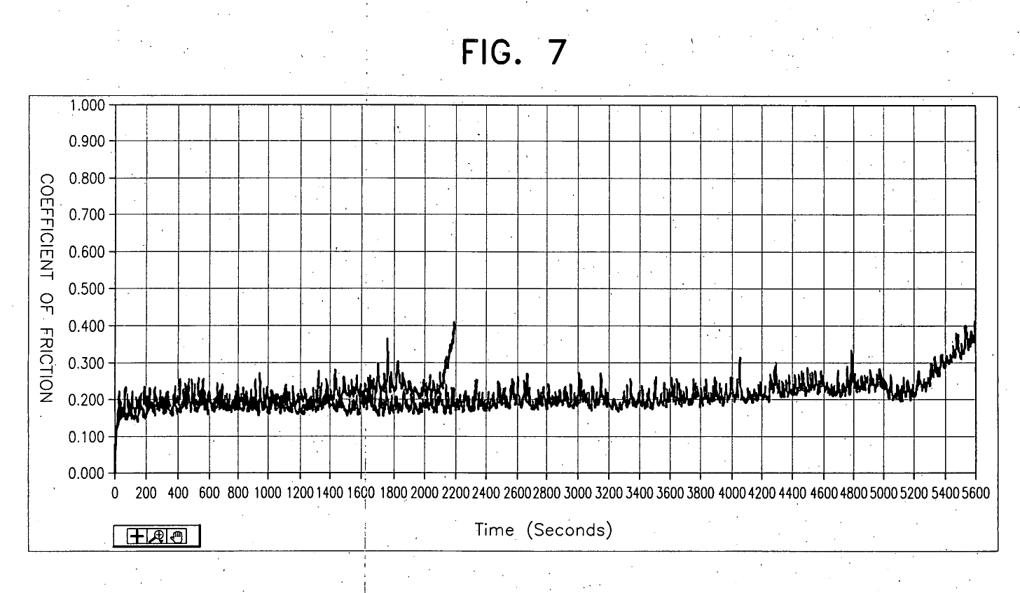

The reduced wear and lowered operating temperature obtained by driving the dry lubricant into the substrate sub-surface through the low temperature diffusion bonding treatment translates into significantly enhanced durability and wear life, extending the duration of the benefit obtained from the dry lubrication treatment well beyond that obtained when the lubricant is applied by conventional shot peening alone. During testing it has been shown that the conduct of the low temperature diffusion bonding process following the shot peening process extends the wear life of the processed disc by 61% to 72% as compared with the wear life of a comparable disc which has not received diffusion bonding processing. Details of this testing are provided in Example IV and summarized in FIGS. 7-11.

Once the low temperature diffusion bonding process has been completed, the treated substrate is ready for use. However, if it is determined that an additional treatment should be applied, step 400, the part can be reprocessed and coated with another layer of dry lubricant, step 450; this step is optional. The need for a second lubricant impingement treatment is generally dependent on the part and its intended end use. Factors to be considered include whether the metal substrate is intended to increase dry lubricity, wear resistance, quick release (i.e., non-sticking effect), and/or operating temperature range.

When a second application is advised, the dry lubricant mixture applied will preferably have a different composition than that used in the first treatment and will generally have polymer compounds mixed in. Polymer compounds, such as PFTE which has a very low melting point, may be used effectively in this second application while being unsuitable for the first treatment in that vaporization thereof would be likely upon subjection to diffusion bonding, even at the low temperatures of the present invention. However, as a second polymer mixed treatment, the inclusion of the polymer is often advantageous and provides an additional level of friction reduction above and beyond the base treatment.

Finally, a last step of cleaning, step 500, is preferably performed in which unbonded lubricant is removed from the substrate by wiping the surface with a dry or damp cloth, or with the application of compressed gas, such as air, argon or nitrogen. The treated part may also be polished in a tumbler with an abrasive media or subjected to sonic cleaning.

Upon completion of the method steps as just described, it is best to package the parts in an inert environment to minimize environmental contamination and protect the surface of the substrate. This may be accomplished through the use of a double-layered bag of polyester and/or polyethylene moisture protection material that is back-filled with an inert gas such as argon and vacuum sealed. The bag may also be filled with nitrogen and vacuum sealed. Other alternative or additional packaging techniques may, of course, be used as would be known by persons of ordinary skill in the art.

The present invention is also directed to a modified substrate produced according to the foregoing method. The modified substrate has an outer surface layer mechanically bonded with a dry lubricant, and a sub-surface layer beneath the outer surface layer into which the dry lubricant has penetrated. The modified sub-surface layer extends beneath the surface layer to a depth of up to 50 microns while the mechanical bonding of the surface layer and the penetration of the dry lubricant into the sub-surface layer changes an overall dimension of the modified substrate by less than 10 microns.

As referenced in brief in the foregoing text and now set forth in full, the following Examples demonstrate the proven benefits obtained with the inventive process and give a more complete understanding thereof.

### EXAMPLE I

Penetration of the dry lubricant into the substrate matrix achieved through low temperature diffusion bonding was demonstrated through comparison with a substrate to which dry lubricant had been applied by impingement but without subsequent low temperature diffusion bonding.

More specifically, a 1 inch by 3 inch sample of 6061 aluminum was treated as follows. The sample was wiped clean and then treated with an aluminum oxide abrasive (size 30 grit at 70 psi). The sample was then blown off with high pressure air and processed by impingement with steel shot (size ES450) coated with a mixture of dry lubricant (MOS₂ and PTFE), and applied at a pressure of 70 psi.

Upon completion of the impingement process, the sample was sectioned into two halves. The first half was set aside and did not undergo further treatment, while the second half was diffusion treated at 400° F. for a duration of four hours. (As the melting point of 6061 aluminum is 1142° F., the diffusion treatment was conducted at less than half the melting temperature for this metal alloy.) After the diffusion treatment was completed, both halves were cross-sectioned, mounted side-by-side and polished for metallographic examination.

As shown in FIG. 2, subsequent visual examination of the two halves under a microscope at 200× magnification revealed that, in the half which had undergone diffusion treatment, the dry lubricant had penetrated into the substrate to a depth of between about 7.96 microns to 10.46 microns. On the sample half that was not diffusion treated, by contrast, there was no visible penetration of the dry lubricant into the substrate.

### EXAMPLE II

The overall dimensional effects of the low temperature diffusion bonding process on high precision metal were evaluated using two-½ inch and two-½ inch cold drawn, turned ground and polished rounds (bars) of 4140 steel. The Ryerson specification for allowable variation in dimensional tolerances for both the ½ inch bar and the ¾ inch bar is 0.001 inches (Reference Specification from “Ryerson Stock List”, Joseph T. Ryerson and Son, Inc. Copyright 1995).

At the outset, ten dimensional measurements were taken along the length of each bar using a Laser Scan Micrometer having a measurement resolution of +/−0.000002 inches. Each bar was then processed in accordance with the present invention. Specifically, the bars were wiped clean and then treated with an aluminum oxide abrasive (size 30 Grit) at 40 psi. The bars were then blown off and subjected to inpingement using steel shot (size ES180) coated with a mixture of dry lubricant of MoS₂ and PTFE and applied at a pressure of 70 psi. The parts were then heat treated for four hours at 400 degrees F. Upon completion of the processing, dimensional measurements were taken which are summarized in Table I; these results are graphically represented in FIG. 3.

As can be seen from the results set forth in Table I, each bar as measured before and after treatment was well within dimensional specifications. The ½-inch A bar had an average dimension of 0.501535 inches with a standard deviation of 0.000449 inches before treatment. This is well within the 0.001 inch specification for this material. After treatment, the ½-inch A bar measured 0.501571 inches with a standard deviation of 0.000658 inches, which is still well within the dimensional specifications.

Table II shows a summary of the dimensional differences between the bars as measured before treatment and after treatment. For the ½ inch A bar, the difference between the average dimensions from each bar before and after treatment is 0.00004 inches. This difference is less than the variation within each bar both before and after treatment and is also two orders of magnitude less than the specification.

As is apparent from review of Tables I and II, all of the bars had similar results, with all of the bars remaining well within dimensional tolerance limits. Therefore, based on this data, it has been demonstrated that treatment of turned, polished and ground bars with the diffusion bonding process results in no significant dimensional change.

TABLE I
Data Summary of Dimensional Measurements Before and After Treatment
Dimensional Comparison, 4140 CD HT TGP (in inches)

| | ½ inchA | ½ inchB | ¾ inchA | ¾ inchB |
|---|---|---|---|---|
| Before | 0.501486 | 0.501398 | 0.75059 | 0.750204 |
| | 0.501834 | 0.501022 | 0.750328 | 0.750378 |
| | 0.50135 | 0.501476 | 0.750034 | 0.750844 |
| | 0.501802 | 0.501752 | 0.75069 | 0.750946 |
| | 0.50113 | .5-1782 | 0.750078 | 0.749238 |
| | 0.501008 | 0.501726 | 0.749872 | 0.749022 |
| | 0.501126 | 0.5012 | 0.749822 | 0.74891 |
| | 0.501204 | 0.501148 | 0.749376 | 0.749172 |
| | 0.502234 | 0.50073 | 0.750448 | 0.750356 |
| | 0.502176 | 0.500628 | 0.750436 | 0.750092 |
| Average | 0.501535 | 0.501231 | 0.750167 | 0.749916 |
| Stdev | 0.000449 | 0.000376 | 0.000406 | 0.000765 |
| After | 0.501536 | 0.502245 | 0.750472 | 0.750126 |
| | 0.5 | 0.501098 | 0.750738 | 0.750026 |
| | 0.501832 | 0.50104 | 0.749556 | 0.749984 |
| | 0.501956 | 0.500826 | 0.749422 | 0.749966 |
| | 0.501042 | 0.500918 | 0.749172 | 0.749976 |
| | 0.501256 | 0.500764 | 0.750154 | 0.749986 |
| | 0.501538 | 0.501072 | 0.750174 | 0.74989 |
| | 0.501876 | 0.501156 | 0.750132 | 0.749862 |
| | 0.502322 | 0.501208 | 0.750264 | 0.750048 |
| | 0.502354 | 0.50196 | 0.750704 | 0.751536 |
| Average | 0.501571 | 0.501229 | 0.750079 | 0.75014 |
| Stdev | 0.000658 | 0.000486 | 0.000533 | 0.000496 |

TABLE II
Difference in Dimensional Measurements Before and After Treatment
Summary of Dimensions (in inches)

| | ½ inch, A | ½ inch, B | ¾ inch, A | ¾ inch, B |
|---|---|---|---|---|
| Before | 0.501535 | 0.501231 | 0.750176 | 0.749916 |
| After | 0.501575 | 0.501229 | 0.750079 | 0.75014 |
| Difference | 0.00004 | 0.000002 | 0.000097 | 0.000224 |

### EXAMPLE III

Tests were conducted to determine friction and operating temperature reduction obtained as a result of low temperature diffusion bonding. Testing was performed to ASTM standard G99 which measures the friction of a metal ball (pin) under an applied load (force) as it slides on a rotating disc. Two discs were tested, each with a corresponding ball (pin).

In this test, the balls (pins) used were ball bearings of Grade 25, AISI 52100 bearing steel (melting point 2595 degrees F.), hardness 62 (Rc) and surface roughness 2 Ra. The discs used were EN 31 (52100) bearing steel, with surface roughness 16 Ra. One disc did not undergo any treatment. The second disc was processed as follows.

The processed disc was wiped clean and then treated with an aluminum oxide abrasive (size 30 grit) at 40 psi. The disc was blown off with high pressure air and subjected to impingement using steel shot (size ES 180) coated with a mixture of dry lubricant of MOS₂ and PTFE and applied at a pressure of 70 psi. The disc was then diffusion treated by heating at 400 degrees F. for four hours.

Two test conditions were evaluated. Test condition “X” had an untreated ball bearing on the untreated disc. Test condition “Y” had an untreated ball bearing on the diffusion bonding treated disc. For both of the test conditions, the operational parameters were the same, namely a sliding speed of 7 m/s, a load of 3 Kg, and an initial contact pressure of 2.0 GPa.

The raw data obtained from these two test conditions is graphically illustrated in FIG. 4. As shown, under test condition “X” represented by the top line, the average coefficient of friction was 0.55. Under test condition “Y” represented by the bottom line, by contrast, the average coefficient of friction was 0.08, representing a decrease in friction of about 85%.

Test condition “Y” also resulted in a significant decrease in operating temperature, as shown graphically in FIG. 5. Specifically, under test condition “X” represented by the top line, the average temperature was 120 degrees C., while under test condition “Y” represented by the bottom line, the average temperature was 40 degrees C.

The reduced friction and lowered temperature obtained with the diffusion treated disc resulted in significantly less actual wear on the ball bearing. More particularly, the ball bearing running under test condition “X” showed 82% more wear than the bearing running on the treated disc of test condition “Y”. The impact of this wear reduction is clearly evident in FIG. 6, in which the ball on the left had been treated in accordance with the present invention and demonstrated 0.90 mm of wear, while the ball on the right had not been treated and demonstrated 4.9 mm of wear. In addition, as these tests were conducted with only one diffusion treated contact surface, further reductions in wear, friction and temperature can be expected for test conditions in which both contact surfaces have undergone diffusion treatment.

### EXAMPLE IV

Durability resulting from the conduct of a low temperature diffusion bonding process following impingement was evaluated as compared with the wear life of a comparable non-treated surface to assess the effectiveness and practical feasibility of the impingement process with and without the process step of diffusion treatment. Testing was performed to ASTM standard G99 which measures the friction of a metal ball (pin) under an applied load (force) as it slides on a rotating disc. Test comparisons were conducted under various loads, and each comparison was based upon the length of time that elapsed before failure occurred. Failure was defined to have occurred when, under the subject test conditions, the coefficient of friction reached 0.4. Each comparison was run until failure occurred.

In each test comparison, the balls (pins) used were a rolling bearing steel (hardness 62 (Rc)), and the discs used were EN 31 (52100) bearing steel. Within each comparison, the operational parameters were the same, with each comparison involving two discs, for a total of four pairs of discs. Each pair of discs was initially processed as follows.

The discs were wiped clean and then treated with an aluminum oxide abrasive (size 30 grit) at 40 psi. Both discs were blown off with high pressure air and subjected to impingement using steel shot (size ES 180) coated with a mixture of dry lubricant of MoS₂ and PTFE and applied at a pressure of 70 psi. Thereafter, only one disc was diffusion treated at 400 degrees F. for four hours, a treatment temperature well below half the melting point for 51200 steel (2595 degrees F.). The other disc, which had received the exact same impingement processing, did not receive any diffusion treatment and is referred to hereafter as the “untreated disc”.

Comparison One

Under the first set of test conditions, the first pair of discs were run under the same first set of test parameters: a speed of 0.75 m/s, a test diameter of 20 mm, a load of 1 Kg, and an initial contact pressure of 1.4 GPa. The test results, which are summarized in FIG. 7, show that the disc treated with the diffusion bonding process, represented by the bottom line, ran for a duration of 5596 seconds before failure occurred. The untreated disc, by comparison, failed after running for a duration of only 2184 seconds, as represented by the top line. Accordingly, the duration to failure for the disc treated with the diffusion process was 61% longer than the corresponding duration to failure of the untreated disc.

Comparison Two

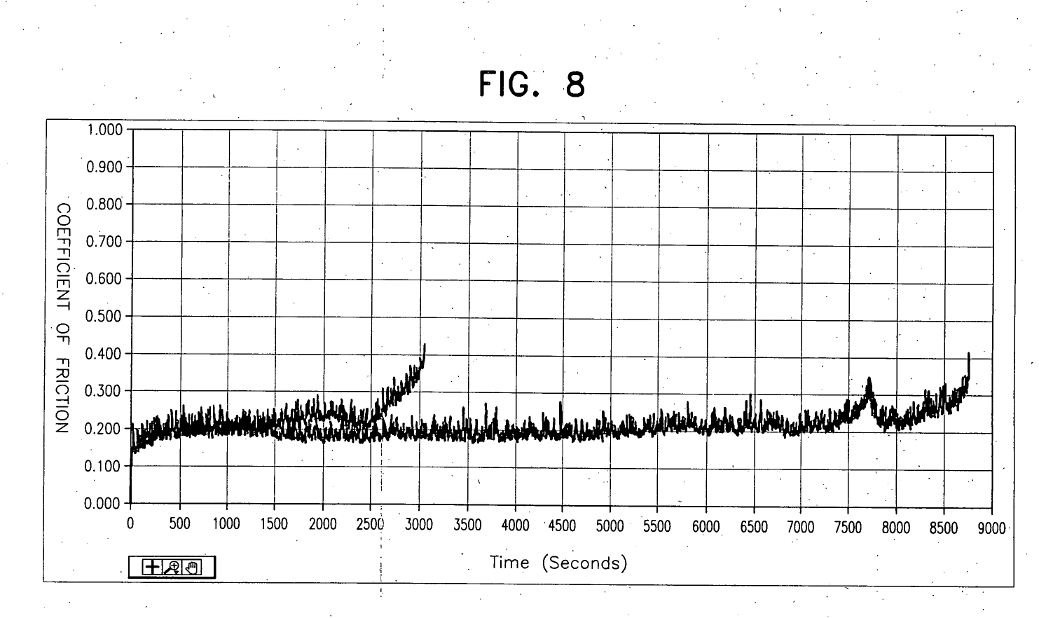

Under the second set of test conditions, the second pair of discs were run under the same second set of test parameters: a speed of 0.75 m/s, a test diameter of 50 mm, a load of 1 Kg, and an initial contact pressure of 1.4 GPa. The test results, which are summarized in FIG. 8, show that the disc treated with the diffusion bonding process, represented by the bottom line, ran for a duration of 8750 seconds before failure occurred. The untreated disc, by comparison, failed after running for a duration of only 3037 seconds, as represented by the top line. Accordingly, the duration to failure for the disc treated with the diffusion process was 65% longer than the corresponding duration to failure of the untreated disc.

Comparison Three

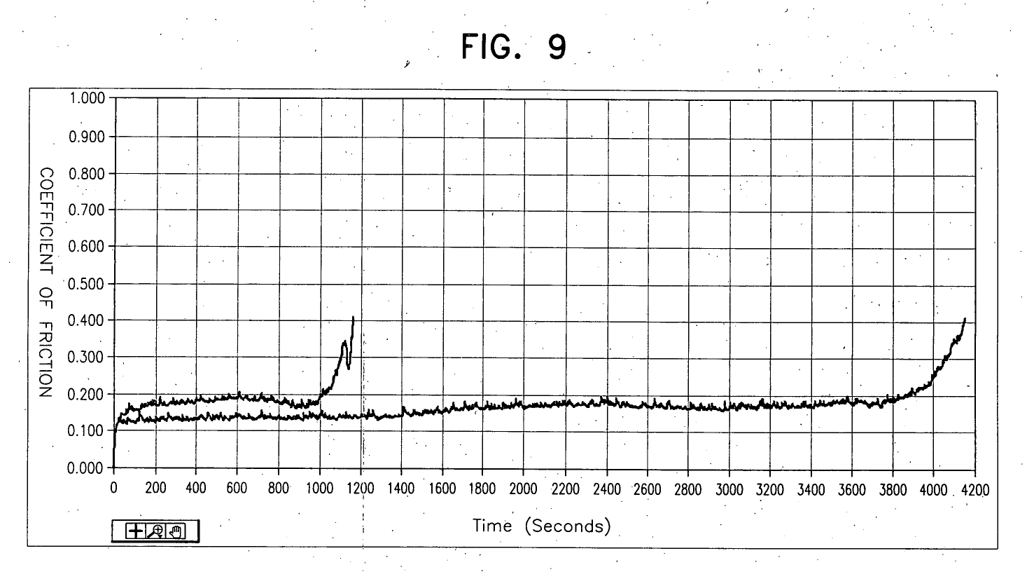

Under the third set of test conditions, the third pair of discs were run under the same third set of test parameters: a speed of 0.75 m/s, a test diameter of 40 mm, a load of 3 Kg, and an initial contact pressure of 2.0 GPa. The test results, which are summarized in FIG. 9, show that the disc treated with the diffusion bonding process, represented by the bottom line, ran for a duration of 4154 seconds before failure occurred. The untreated disc, by comparison, failed after running for a duration of only 1160 seconds, as represented by the top line. Accordingly, the duration to failure for the disc treated with the diffusion process was 72% longer than the corresponding duration to failure of the untreated disc.

Comparison Four

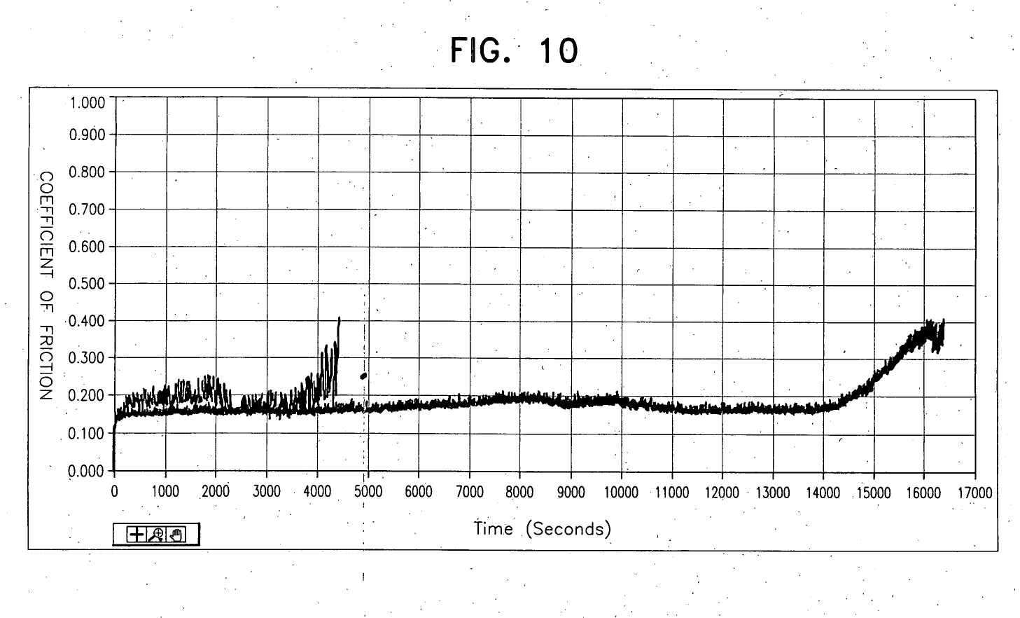

Under the fourth set of test conditions, the fourth pair of discs were run under the same fourth set of test parameters: a speed of 0.75 m/s, a test diameter of 130 mm, a load of 3 Kg, and an initial contact pressure of 2.0 GPa. The test results, which are summarized in FIG. 10, show that the disc treated with the diffusion bonding process, represented by the bottom line, ran for a duration of 16384 seconds before failure occurred. The untreated disc, by comparison, failed after running for a duration of only 4417 seconds, as represented by the top line. Accordingly, the duration to failure for the disc treated with the diffusion process was 72% longer than the corresponding duration to failure of the untreated disc.

### SUMMARY

The above four comparative pin-on-disc test results for test conditions executed at various loads and test diameters for a diffusion treated versus a non-diffusion treated disc are summarized in FIG. 11. In all cases, the useful wear life of the disc with the diffusion treatment condition was significantly extended as compared with that of the corresponding disc which had not been subjected to the diffusion treatment, for an average increase in wear life of approximately 67%.

The foregoing description and drawing should be considered as illustrative only of the principles of the invention. Numerous applications of the present invention will readily occur to those skilled in the art. Therefore, it is not desired to limit the invention to the specific examples disclosed or the exact implementation shown and described. Rather, all suitable modifications and equivalents may be resorted to, falling within the scope of the invention.

What is claimed is:

1. A process of modifying a surface and a sub-surface of a metal substrate for reduced friction, comprising the steps of:
providing a mixture of peening particles coated with dry lubricant;
impacting said mixture against the surface of said substrate at a velocity which is sufficient to cause said peening particles to compress said surface and simultaneously bond said dry lubricant to said substrate surface; and
treating the substrate with a low temperature diffusion bonding process at a temperature less than half a melting point of said metal substrate to cause the dry lubricant to penetrate into said sub-surface beneath the surface of the substrate.

2. The process as set forth in claim 1, wherein said step of treating the substrate with a low temperature diffusion bonding process includes subjecting said substrate to a temperature of about 400 degrees F. for a duration of from 0.5 to 4.0 hours.

3. The process as set forth in claim 1, wherein said diffusion bonding process is conducted in a non-reactive environment.

4. The process as set forth in claim 1, wherein said diffusion bonding process is conducted for a duration of from about 0.5 to 4.0 hours.

5. The process as set forth in claim 1, wherein said diffusion bonding process modifies the sub-surface of the substrate to a depth of approximately 2-50 microns.

6. The process as set forth in claim 1, wherein said diffusion bonding process occurs at a temperature that is at least 2% of said melting point.

7. The process as set forth in claim 1, wherein said diffusion bonding process occurs at a temperature that is about 35% of said melting point.

8. The process as set forth in claim 1, further comprising, before the step of impacting, the steps of preparing said substrate surface by first cleaning said surface using an abrasive media applied by dry blasting, and then removing residual abrasive media using compressed gas.

9. The process as set forth in claim 8, wherein said abrasive media includes glass beads and said peening particles include steel shot.

10. The process as set forth in claim 1, wherein said step of impacting is conducted in a cabinet enclosure using nozzles to direct the peening particles, said nozzles being about four inches from said substrate surface having a nozzle pressure in a range of 80-120 psi.

11. The process as set forth in claim 1, wherein said step of impacting is conducted for a duration of about one to ten minutes.

12. The process as set forth in claim 1, wherein said substrate is a metal part and said step of treating the substrate increases an overall outer dimension of said part by less than 10 microns.

13. A method of producing a reduced friction surface on a substrate, comprising the steps of:
preparing the substrate surface through impingement of said surface with an abrasive media to clean said surface;
coating nonabrasive peening particles with a dry lubricant;
impacting the substrate surface with the coated peening particles at a sufficient velocity to fuse the dry lubricant to said substrate surface and form a pressure bond; and
conducting a low temperature diffusion bonding process on said substrate after said impacting step, said low temperature diffusion bonding process being conducted at a temperature greater than 2% and less than 50% of a melting point of said substrate and causing at least a portion of said pressure bonded dry lubricant to migrate through the substrate surface and into an underlying sub-surface of said substrate.

14. The process as set forth in claim 13, wherein said step of conducting the low temperature diffusion bonding process is done at a temperature of about 35% of said melting point of said substrate.

15. The process as set forth in claim 13, wherein said step of conducting the low temperature diffusion bonding process is done at a temperature of about 400 degrees F. for a duration of about 0.5 to 4.0 hours.

16. The process as set forth in claim 13, wherein said step of conducting said low temperature diffusion bonding process is performed until said portion of said pressure bonded dry lubricant penetrates into the substrate matrix to a depth of between about 2 and 50 microns.

17. The process as set forth in claim 13, wherein said step of coating includes application of a dry lubricant of MOS₂ and PTFE to peening particles of stainless steel shot, and mixing said dry lubricant and said peening particles in an agitation device for about 10-80 minutes.

18. The process as set forth in claim 13, wherein said diffusion bonding process is conducted in a non-reactive environment.

19. The process as set forth in claim 13, wherein said abrasive media includes glass beads and said peening particles include steel shot.

20. The process as set forth in claim 13, wherein said step of impacting is conducted for a duration of about one to ten minutes in a cabinet enclosure using nozzles to direct the peening particles, said nozzles being about four inches from said substrate and having a nozzle pressure in a range of 80-120 psi.

21. The process as set forth in claim 13, wherein said substrate is a metal part and said step of conducting a low temperature diffusion bonding process increases an overall outer dimension of said part by less than 10 microns.

22. A modified substrate having enhanced low friction characteristics, comprising:
an outer surface layer mechanically bonded with a dry lubricant; and
a sub-surface layer beneath said outer surface layer into which said dry lubricant has penetrated.

23. The modified substrate as set forth in claim 22, wherein said substrate is metal and said outer surface layer is metallurgically bonded with said dry lubricant.

24. The modified substrate as set forth in claim 22, wherein said sub-surface layer extends beneath said surface layer to a depth of up to 50 microns.

25. The modified substrate as set forth in claim 22, wherein said sub-surface layer extends beneath said surface layer to a depth of at least 2 microns.

26. The modified substrate as set forth in claim 22, wherein said surface layer has a coefficient of friction approximately 85% lower than a corresponding coefficient of friction associated with the substrate before being modified.

27. The modified substrate as set forth in claim 22, wherein the mechanical bonding of the surface layer and the penetration of the dry lubricant into said sub-surface layer changes an overall dimension of said modified substrate by less than 10 microns.

28. A modified substrate having enhanced low friction characteristics, comprising:
an outer surface mechanically bonded with a dry lubricant by impacting a mixture of peening particles coated with dry lubricant against said substrate at a velocity which is sufficient to cause said peening particles to compress said substrate and simultaneously bond said dry lubricant to the outer surface of said substrate; and
a sub-surface layer beneath said outer surface into which said dry lubricant has been driven by subsequently treating the mechanically bonded substrate with a low temperature diffusion bonding process at a temperature that is at least 2% and less than 50% of a melting point of said substrate.

29. The modified substrate as set forth in claim 28, wherein said substrate is metal and said outer surface is metallurgically bonded with said dry lubricant.

30. The modified substrate as set forth in claim 29, wherein said sub-surface layer is formed by said low temperature diffusion bonding process conducted at a temperature of about 400 degrees F. for a duration of from 0.5 to 4.0 hours.

31. The modified substrate as set forth in claim 28, wherein said sub-surface layer is formed by said low temperature diffusion bonding process conducted in a non-reactive environment.

32. The modified substrate as set forth in claim 28, wherein said sub-surface layer is formed by said low temperature diffusion bonding process conducted at a temperature that is approximately 35% of said melting point.

33. The modified substrate as set forth in claim 28, wherein said sub-surface layer extends beneath said surface to a depth of between about 2-50 microns.

34. The modified substrate as set forth in claim 28, wherein the mechanical bonding of the surface with the lubricant and the penetration of the dry lubricant into said sub-surface layer by low temperature diffusion bonding changes an overall outside dimension of said modified substrate by less than 10 microns.
